(19) United States
(12) Patent Application Publication
(10) Pub. No.: US 2014/0006570 A1
(43) Pub. Date: Jan. 2, 2014

(54) METHOD AND SYSTEM FOR CUSTOMER SPECIFIC TEST SYSTEM ALLOCATION IN A PRODUCTION ENVIRONMENT

(71) Applicants: Christian Loos, Dresden (DE); Hendrik Richter, Dresden (DE); Ralf Jantschke, Ottendorf-Okrilla (DE); Karsten Jaehnigen, Dresden (DE)

(72) Inventors: Christian Loos, Dresden (DE); Hendrik Richter, Dresden (DE); Ralf Jantschke, Ottendorf-Okrilla (DE); Karsten Jaehnigen, Dresden (DE)

(73) Assignee: GLOBALFOUNDRIES INC., Grand Cayman (KY)

(21) Appl. No.: 13/537,684

(22) Filed: Jun. 29, 2012

(51) Int. Cl. G06F 15/177

(52) U.S. Cl. 709/220

(57) ABSTRACT

In complex production environments, such as a semiconductor production facility, allocation of test systems for external control is handled on the basis of an allocation system and technique in which enhanced data integrity is ensured. To this end, direct access to facility internal communication resources is prevented, while nevertheless providing external access to the test systems.

### BACKGROUND OF THE INVENTION

1. Field of the Invention

The present disclosure generally relates to systems and techniques for testing products in a complex production environment, such as a semiconductor production environment.

2. Description of the Related Art

In complex production environments, high yield and superior reliability and quality of the products are of immense importance in today's highly competitive global markets. For example, in manufacturing semiconductor devices including a relatively complex circuitry, the testing of the device may represent a part of the manufacturing process which has been underestimated a long time in terms of cost and effort required to obtain reliable data with respect to proper functionality and reliability of the device. In this respect, the manufacturing of the complex semiconductor device is to be understood to include the design of the device on the basis of a functional description of the desired functional behavior of the device, the various stages of providing a preliminary representation of the device in the form of a software model or a hardware prototype and respective redesigned versions thereof after encountering failures during verification, as well as the actual implementation of the finally established design in the semiconductor material. Thus, one reason in failing to meet performance specifications of the integrated circuit may reside in design errors that may be identified and remedied by circuit verification on the basis of software simulation and/or prototype testing prior to mass production of the integrated circuits under consideration. An improper functionality of the integrated circuit may further be caused by the complex manufacturing process itself when the completed circuitry does not correspond to the verified circuit design owing to process fluctuations in one or more of the large number of process steps involved during the processing of the device. Although measurement and test procedures are incorporated at many points in the manufacturing process, it is nevertheless extremely important to ascertain the correct functioning of the final semiconductor device, since, according to a common rule of thumb, the costs caused by defective chips increase with each assembly phase by approximately one order of magnitude. For example, the costs caused by a defective circuit board including a faulty chip are typically significantly higher than identifying a defective chip prior to shipping and assembling the circuit board. The same holds true for a system, when a failure thereof is caused by one or more defective circuit boards, as a downtime of an industrial system may result in averaged costs of approximately several hundred dollars per minute compared to a price of a few dollars for an integrated circuit chip having caused the defect.

Hence, there is a vital interest in developing test procedures so as to identify as many defects as possible in completed integrated circuits while not unduly increasing the total manufacturing costs. In particular, with the demand for more features and lower costs of circuits, there is a tendency to integrate a plurality of different circuit portions into a single chip so as to provide a complete system on a chip (SoC). A semiconductor device comprising various functional blocks may typically include, in addition to one or more logic blocks, one or more embedded memory portions, such as are used as on-chip cache for CPUs or as buffers for data packets that are transferred between different clock domains, and other peripheral components, such as complex I/O devices, dedicated functional blocks for efficient data processing of a specific type and the like, wherein these peripheral blocks are operatively connected to the CPU of the system via appropriate bus systems.

As discussed above, economic constraints force semiconductor manufacturers to not only minimize the defect level of the total manufacturing process, but also to provide, in combination with a reduced defect level, high fault coverage so as to reduce the delivery of defective chips at a reasonable cost for appropriate test procedures and techniques. For these reasons, appropriate test resources have to be implemented into a complex production environment in order to precisely control the manufacturing flow. To this end, automated test systems have been developed, which may provide the possibility of obtaining measurement results at various stages of the overall manufacturing process, thereby allowing superior overall process control and production yield. Although these automated test systems may primarily be used for monitoring and controlling the production process in the production environment, it is also extremely important to correlate the measurement results with the basic circuit design, since the available technology may have a significant influence on the capability of actually implementing a complex circuit design.

With reference to FIGS. 1a-1c, a typical implementation and process strategy in producing measurement results for complex products, such as semiconductor devices, will now be described in more detail.

FIG. 1a schematically illustrates a production environment 100, which represents a complex semiconductor production environment that is appropriately equipped in order to produce semiconductor devices, such as microprocessors, storage devices, ASICs (application specific ICs) and the like. The production environment 100 comprises a plurality of process tools 110, which are used for performing the various complex process steps so as to form a completed semiconductor device or any appropriate intermediate stage of a semiconductor device. For example, process tools 110A . . . 110N in the form of lithography tools, etch tools, implantation tools and the like are provided and operated in accordance with specific process recipes in order to provide a desired process output when processing products 111, such as semiconductor wafers. In sophisticated production environments, at least some of the process tools 110 are appropriately configured so as to communicate with each other and/or with a supervising control mechanism (not shown), wherein the corresponding communication capabilities are typically provided by a local or internal network 120, which is to be understood as an entirety of software and hardware resources required for establishing the necessary communication capabilities within the production environment 100. For example, the internal network 120 may allow communication with one or more of the process tools 110 so as to obtain process related data, which may be stored and/or processed in any appropriate manner by an entity 133, which may be provided in the form of a database and the like so as to allow the storage and/or processing of historical data relating to the processing of one or more types of products 111 in the environment 100.

Furthermore, the production environment 100 may further comprise entities 131 and/or 132, which are configured to receive and store measurement results obtained from any measurement procedures performed during the processing of the products 111 or at a final stage of the overall production process. For example, the entity 131 may represent a database including measurement results in any appropriate form, which have been obtained on the wafer basis upon performing measurement processes and test procedures carried out on some or all of the semiconductor devices provided on a wafer. For instance, electrical tests may be performed by using automated test systems (not shown) in combination with specific test structures provided in the scribe line areas of the wafers or in combination with actual semiconductor devices in order to obtain specific electrical parameters and the like. During these electrical test procedures, transistor characteristics may be determined, such as dielectric strength of certain device areas, electrical response of functional blocks and the like. It should be appreciated that corresponding measurement procedures may be performed at any appropriate stage during the entire manufacturing flow, as long as respective test structures or actual device structures may be accessed by automated test equipment.

Similarly, an entity 132 may represent a database for storing measurement results, which may be obtained in one or more final test procedures, i.e., test procedures carried out on packaged semiconductor devices, thereby providing the possibility of determining performance characteristics, process quality, reliability and the like after completing the entire production process. Also in this case, automated test equipment is used in combination with appropriate test algorithms in order to provide high failure coverage at reasonable effort in terms of time and required equipment resources.

The data available from one or more of the entities 131, 132 and 133 may be communicated to a data storage and manipulation unit 134, which may thus provide output data 136 that indicates a measure of important product related parameters, such as reliability, performance, production yield and the like. In other cases, in addition to or alternatively, the entity 134 may output appropriate data 136 or may provide appropriate data to a further data manipulation unit (not shown) in order to provide global feedback information for controlling the overall process flow performed by the process tools 110. Typically, the entire data traffic within the production environment 100 is handled by the internal network 120, thereby allowing the implementation of highly automated and advanced process control strategies, since typically an enormous amount of data is produced during the manufacturing flow and the various test processes.

FIG. 1b schematically illustrates a portion 140 of the production environment 100, which may represent a test environment in order to obtain relevant measurement results at any appropriate stage of the overall production process. As illustrated, the test environment 140 comprises one or more test systems, wherein, for convenience, only a single test system 140A is depicted. The test system 140A comprises automated test equipment 141 which in turn includes any required resources for appropriately contacting respective test structures or actual semiconductor devices provided on a wafer or encapsulated in an appropriate package. Furthermore, the system 140A comprises a substrate handler 143, which receives respective devices under test, such as the products 111 in the form of semiconductor wafers or packaged devices, which are then appropriately transferred to the unit 141. Furthermore, typically, a controller 142 is provided in the system 140A, which is appropriately configured so as to control the various hardware and software resources of the system 140A and also to receive measurement results from the unit 141 and/or from a corresponding test program 144 that is typically implemented in the unit 141 so as to carry out a desired test procedure in compliance with the requirements of a corresponding product. The communication between the controller 142 and the system internal components is typically established on the basis of a system internal bus system 145. It should be appreciated that respective automated test systems, such as the system 140A, are typically well established in the art and thus a more detailed description thereof is omitted.

Furthermore, the test system 140A communicates with other entities of the production environment 100 via the network 120, as previously discussed. For example, measurement results may be communicated to the database 131 and/or the database 132, depending on the type of test procedure carried out by the system 140A. Furthermore, the system 140A may be accessed via the network 120 in order to implement a desired test strategy, which may be accomplished by appropriately instructing the controller 142 so as to re-configure the test program 144. To this end, an appropriate control mechanism 137, instructed by a supervising control mechanism (not shown) and/or by an operator within the environment 100, may be connected to the network 120.

Consequently, during operation of the environment 100, products 111 may be continuously processed by the process tools 110 (FIG. 1a) and may be handled at any appropriate stage by the test system 140A, which in turn provides measurement data that enables the estimation of product performance, reliability and the like, as discussed above. As previously explained, however, the high complexity of the process of forming very complex products, such as complex semiconductor devices, has increasingly resulted in a separation of the various stages of the overall manufacturing process. That is, frequently, the process of designing a complex semiconductor device including the various test procedures based on software representations of the complex semiconductor device is carried out by a specialized party, while actual process technology is provided by a different party, who is specialized in operating complex process tools so as to provide a plurality of technologies as required for implementing complex circuit designs of different circuit design. On the other hand, as discussed above, the implementation of a specific technology, which is typically accompanied by the respective process technology dependent fluctuations, may also significantly affect the basic design of complex circuitry, thereby requiring intensive communication between the circuit designer and the manufacturer who provides the hardware resources for implementing a production process. For example, designing a cutting edge semiconductor device with reduced critical dimensions and based on certain technological specifics, such as the configuration of sophisticated gate electrode structures of field effect transistors and the like, may require a thorough knowledge of the process capabilities of the manufacturer, since, for instance, device performance may critically depend on critical signal paths, the characteristics of which depend on a tightly set tolerance range for certain critical processes.

FIG. 1c schematically illustrates the production environment 100, which is connected to a plurality of remote parties, which are also indicated as customers 180. For example, as illustrated, customers 180A, 180B, 180C communicate with the environment 100 by means of an external communication network 170, which may represent a plurality of individual customer networks or which may represent a global wide area network (WAN), such as the Internet and the like. It should be appreciated that any respective software and hardware resources in the network 170 and in the customer systems 180 required for communication are not shown. Any such hardware and software resources, however, are well known in the art. For example, the customers 180 may represent appropriate computer systems having appropriate components, such as routers, network switches and the like, in order to connect to the network 170, which in turn provides respective communication channels, such as wired and wireless communication channels, as is well known.

Similarly, the environment 100 is connected to the external network 170 by providing an appropriate communication component 160, which thus connects the network 170 with the internal network 120, wherein the component 160 may be implemented in hardware and software or software only, depending on the overall requirements. For example, the component 160 may represent a specific hardware component running an appropriate server software that allows the customers 180 to access one or more test systems 140A, 140B, 140N via the network 170, the communication component 160 and the internal network 120. Hence, upon processing different types of products in the environment 100, which may include the generation of respective test data by means of the test systems 140A . . . 140N, a specific one of the test systems may be assigned to a specific one of the customers 180 so as to appropriately adapt the test procedure to the one or more types of products produced for the specific customer. On the other hand, data integrity should be preserved for each of the different customers 180 with respect to the test measurements associated with the respective customers, since the measurement results as well as the corresponding test procedures applied in the various test systems may contain information about design specifics of the various products produced in the environment 100. However, full access for each of the customers 180 to a dedicated test system may result in undesired data transfer between the various customers, in particular when test systems have to be dynamically re-assigned in order to enhance overall efficiency in the production environment 100. Furthermore, access to the internal network 120 by the customers 180 may result in data corruption within the environment 100, even if the communication unit 160 may have implemented therein conventional hardware and software resources, such as a firewall and the like, in order to restrict unauthorized access to the internal network 120. Moreover, the configuration of the communication infrastructure shown in FIG. 1c may also result in reduced security of the internal network 120, when full access to the test systems 140A . . . 140N is required by internal resources of the environment 100 in order to perform efficient test operations on corresponding products.

In view of the situation described above, the present disclosure relates to a production environment and methods of operating the same, while avoiding or at least reducing the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure relates to a production environment and methods implemented therein. In one illustrative embodiment, the production environment is a semiconductor production environment, wherein superior data integrity and flexibility in allocating a test system to a customer is accomplished. To this end, one or more test systems of the production environment may be accessed by an internal network and by one or more external networks so as to provide in situ control functionality and remote control functionality, while at the same time remote access to the internal network via the one or more external networks is prevented. Furthermore, in some illustrative embodiments, a dynamic re-allocation of test systems may be provided on the basis of superior data integrity by “cleaning” a respective test system prior to allowing remote control of the test system by a different customer. Consequently, according to the principles disclosed herein, secure test operations of one or more test systems within the production environment may be accomplished by internal resources, although the one or more test systems may be assigned to remote customer computer systems. Furthermore, an appropriate test system environment may be provided for one or more external sources, thereby enabling superior efficiency in obtaining and manipulating measurement data. The one or more test systems may be assigned to different customers in a dynamic manner so as to provide full external access to the one or more test systems, however, without compromising data security within the production environment. Also, unwanted data transfer between external sources may be prevented.

In one embodiment, a production environment includes a test system configured to automatically obtain test data from products produced in the production environment. The production environment further includes a first communication network configured to enable communication of entities within the production environment. The production environment further includes a controllable network switch system operatively connected to the first communication network and the test system and connectable to a second communication network configured to enable communication of a remote customer computer system with the test system, wherein the controllable network switch system is configured to enable individual isolation of the first and second communication networks from the test system. Moreover, the production environment includes an allocation unit operatively connected to the controllable network switch system and configured to cause the controllable network switch system to prevent concurrent communication of the first and second networks with the test system.

According to another embodiment, a method of operating a production environment includes allocating a test system of the production environment to a remote customer. Moreover, the method includes re-configuring the test system into a desired state by using an internal communication network of the production environment. The method further includes connecting the test system to an external communication network so as to provide remote control functionality for the test system for the remote customer.

According to yet another embodiment, a method includes providing a plurality of test systems implemented in a production environment, wherein each of the plurality of test systems is connectable to an internal communication network and an external communication network. The external communication network provides remote control functionality with respect to the plurality of test systems for a plurality of remote customers and the internal communication network provides in situ control functionality with respect to the plurality of test systems. The method further includes allocating a respective one of the plurality of test systems to a respective one of the plurality of remote customers. Moreover, the method includes controlling the remote control functionality and the in situ control functionality by preventing concurrent connection of the allocated test system to the internal and external communication networks.

### BRIEF DESCRIPTION OF THE DRAWINGS

The disclosure may be understood by reference to the following description taken in conjunction with the accompanying drawings, in which like reference numerals identify like elements, and in which:

FIGS. 1a-1b schematically illustrate a production environment, such as a semiconductor production environment, in which automated test equipment is used for generating measurement results, according to conventional strategies;

FIG. 1c schematically illustrates the production environment that is configured to allow remote control of test systems by means of an internal network, according to conventional concepts;

FIG. 2a schematically illustrates a production environment including one or more test systems provided in a secure environment so as to provide internal and remote control of the test systems, according to illustrative embodiments;

FIG. 2b schematically illustrates a DMZ (demilitarized zone) including one or more test systems in combination with an associated server infrastructure, according to illustrative embodiments; and

FIGS. 3-5 schematically illustrate various methods of operating the production environment, according to still further illustrative embodiments.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The present disclosure generally provides superior allocation functionality with respect to test systems in a complex production environment, which, in one illustrative embodiment, is a semiconductor production environment, wherein, at the same time, enhanced data security between the production environment and remote customers and between the remote customers may be achieved. To this end, an allocation tool or unit, such as a customer allocation tool (CAT), may be provided in the context of a communication infrastructure, which may allow a dynamic assignment of test systems to a remote customer computer system, while nevertheless preventing direct access of the remote computer system to the internal network of the production environment. To this end, in one illustrative embodiment, the production environment comprises one or more test systems, which may communicate with an internal network and an external network by means of a controllable network switch system. The controllable network switch system is configured to prevent a concurrent communication of the one or more test systems with the internal network and the external network, wherein a corresponding functionality may be controlled or at least monitored and recorded by the customer allocation unit. To this end, the controllable network switch system may comprise well-known hardware and software components, such as a dedicated hardware platform, such as a network switch, and the like, possibly in combination with appropriate firewall software in order to allow connection to the internal and external networks. Additionally, the network switch system may be appropriately equipped so as to prevent a concurrent communication of the one or more test systems with the internal and external networks, which may be accomplished by implementing software and/or hardware components into the switch system so as to controllably connect and disconnect the internal and external networks.

In further illustrative embodiments, allocation of a test system to a remote customer computer system for providing full external control functionality may be associated with a corresponding “cleaning” of the test system under consideration. To this end, the test system under consideration, which may have previously been allocated to a different remote customer computer system or which may otherwise have been used by company internal resources, may be re-configured or re-imaged to establish a predefined state of the test system, thereby particularly removing any data and adjustments associated with the control function carried out by the previous remote customer computer system or company internal resources. In this manner, the newly allocated test system is ready for being controlled by a new remote customer without giving any hint as to the previous test procedure and test data performed and generated therein under the control of the previously assigned remote customer.

The test systems of the production environment may include or may be associated with respective further components, such as various server applications, so that enhanced functionality is provided to a remote customer. On the other hand, the re-configuration of the test system upon being newly allocated to a new customer may also include the re-configuration of the associated infrastructure of the test system, thereby also avoiding unwanted data transfer between remote customers.

Consequently, various tasks associated with the operation of test systems in a production environment may be performed, such as re-allocation or re-assignment of test systems to other remote customers, maintenance of a test system by internal resources and the like, while at the same time external access to critical data in the test systems is prevented.

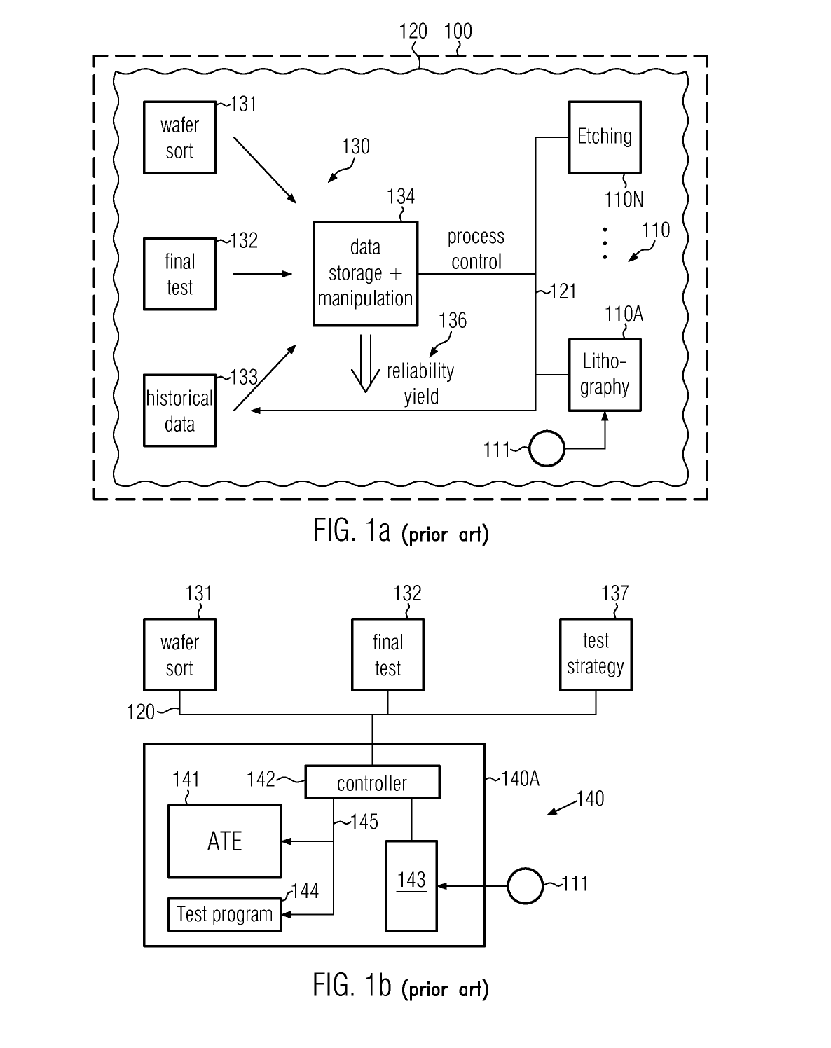

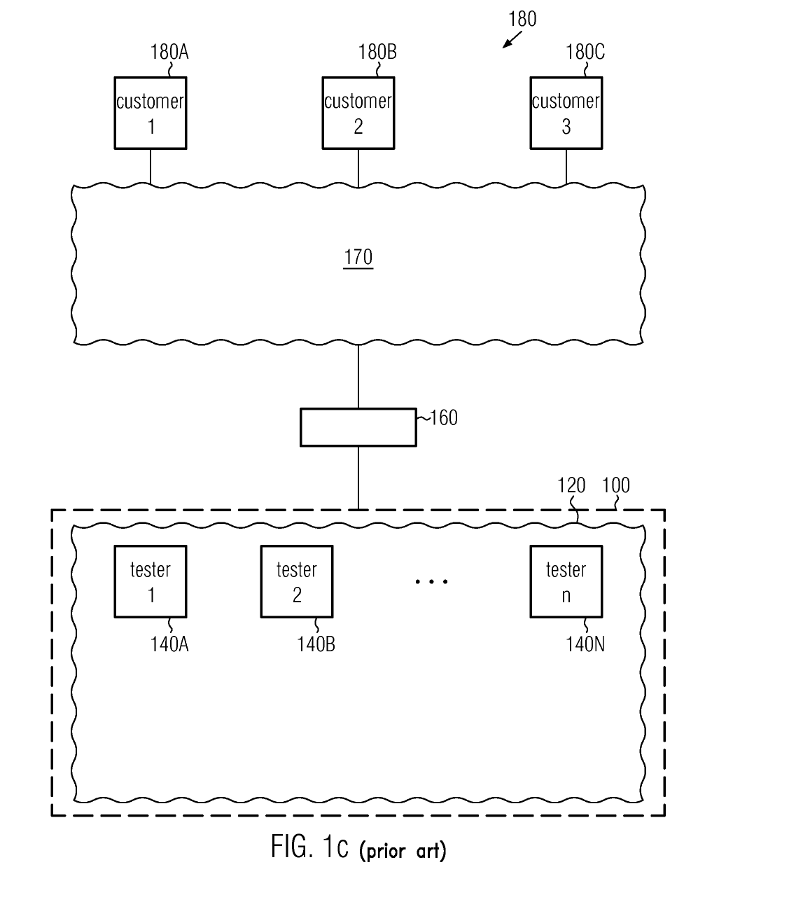

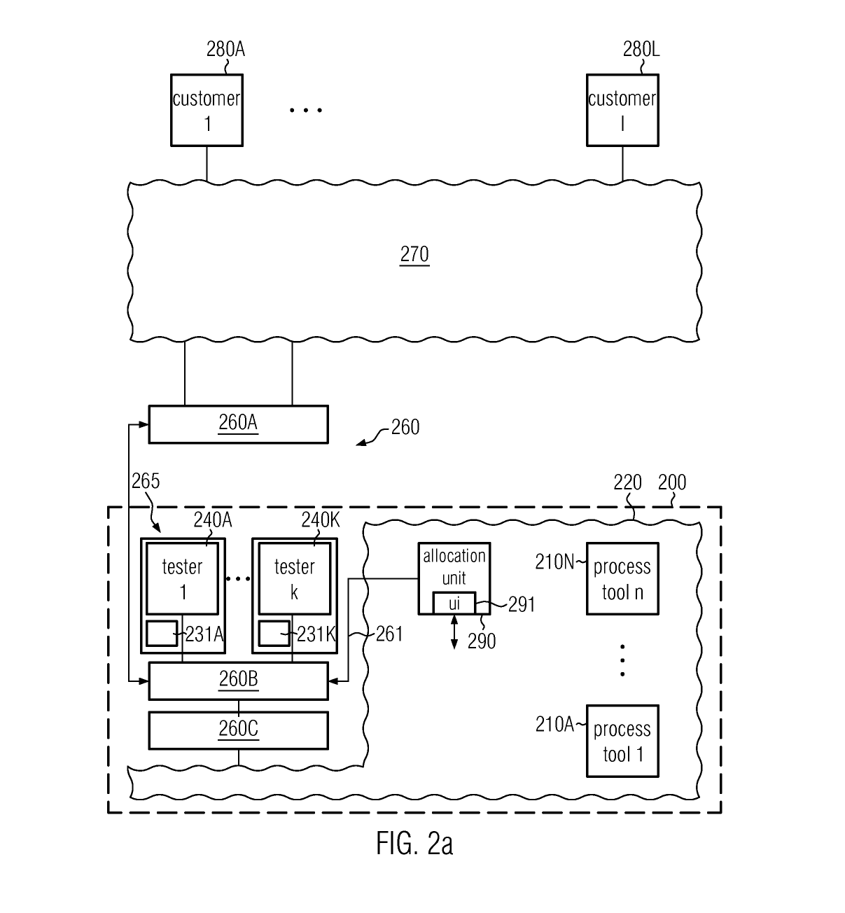

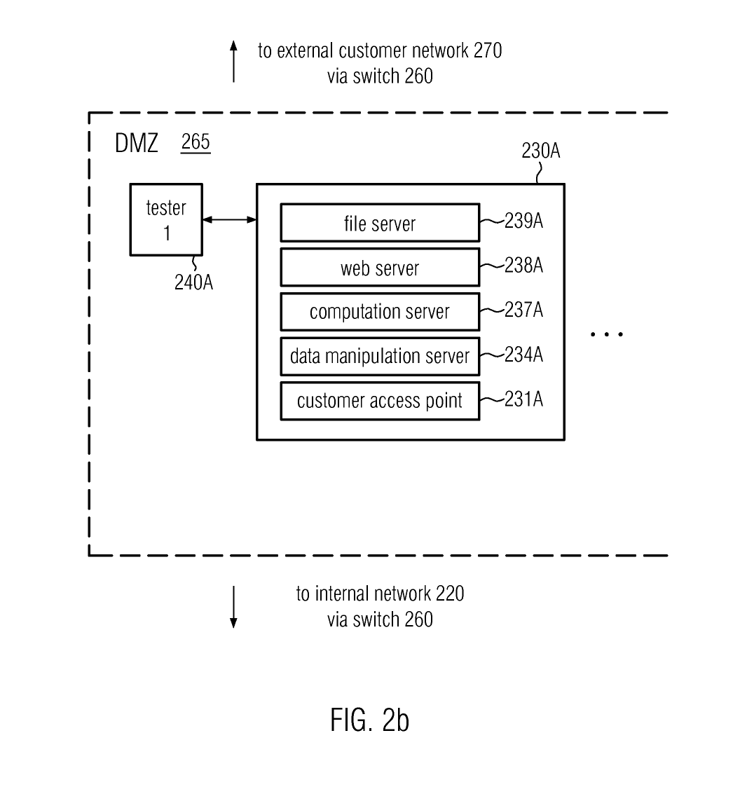

With respect to FIGS. 2a, 2b and 3-5, further illustrative embodiments will now be described in more detail, wherein reference may also be made to FIGS. 1a-1c, if appropriate.

FIG. 2a schematically illustrates a production environment 200, which may represent any complex production environment requiring sophisticated test algorithms and procedures in order to control the overall process flow and achieve the required product performance and quality in combination with high production yield. In one illustrative embodiment, the production environment 200 is a semiconductor production environment, in which semiconductor devices may be manufactured up to a certain stage of completeness. For example, in many semiconductor facilities, semiconductor devices are fabricated by processing semiconductor substrates, while separating the individual semiconductor die on the substrate may be performed in a separate remote location. In other cases, semiconductor devices may be produced in the environment 200 from substantially non-processed substrates to packaged devices.

The environment 200 may comprise a plurality of process tools 210, such as process tools 210A . . . 210N, which may perform any required manufacturing process, inspection process and the like. It should be appreciated that the process tools 210 may communicate with each other and/or with a supervising control mechanism (not shown) in order to organize the overall product flow within the environment 200. The communication capabilities within the environment 200 may be provided by an internal network 220, wherein corresponding interface components (not shown) of the entities within the environment 200 may allow communication over respective communication channels of the network 220, as is well known in the art. For example, the process tools 210 may comprise appropriate interface components providing the hardware and software resources in order to exchange data within the environment 200 via the network 220.

The environment 200 may further comprise a secure zone 265, which may also be referred to as DMZ (demilitarized zone), in which one or more test systems 240A . . . 240K may be positioned, wherein access to the test systems and additional resources associated therewith may be provided by respective access points 231A . . . 231K. The access points thus allow a customer to control the respective test system and access to additional data, once a test system is allocated to a specific customer and the specific customer is allowed to access the test system via the corresponding access point, as will be discussed later on. It should be understood that the secure zone 265 may not necessarily represent a continuous space within the environment 200, but may actually be distributed across the environment 200, if considered appropriate with respect to the overall workflow in the production environment 200. The secure zone 265 may be understood as a “secure” area with respect to data transfer to and from the test systems 240A . . . 240K. That is, the test systems 240A . . . 240K may not be directly connected, via the access points 231A . . . 231K, to the internal network 220, but may communicate with any internal entities in the environment 200 via the network 220 by means of a controllable network switch system 260, which is to be understood as a combination of hardware and software resources that enable communication of internal entities with the test systems 240A . . . 240K on the basis of specifically defined restrictions only. For example, the network switch system 260 may comprise one or more firewalls in order to restrict data traffic between the test systems 240A . . . 240K and the internal network 220 by using predefined rules implemented in the system 260. It should be appreciated that implementing a firewall on the basis of predefined rules or scripts is a well-established technique for restricting data transfer between two communicating entities. Contrary to many conventional firewall applications, however, a static set of rules may be implemented in the system 260, since a dynamic adaptation of the data transfer restrictions may not be necessary, thereby enhancing overall efficiency of the secure zone 265.

In one illustrative embodiment, the controllable network switch system 260 is configured to isolate each of the test systems 240A . . . 240K individually from the internal network 220 upon a corresponding request, which may be provided by an allocation unit 290. To this end, the allocation unit 290 may directly communicate with the system 260 or may communicate with the system 260 via the internal network 220. The isolation of a specific one of the test systems 240A . . . 240K may be realized by physically interrupting a communication channel within the system 260 or by providing corresponding software components, which completely suppress data transfer between the test system under consideration and the internal network 220. The allocation unit 290 may comprise a user interface 291, which enables a user to enter a request or any other input information in the unit 290. Moreover, the interface 291 may display or otherwise indicate output information to the user, for instance with respect to the connection status of the system 260 and thus of the test systems 240A . . . 240K. In one illustrative embodiment, as shown in FIG. 2a, the system 260 may comprise a first communication unit 260B in the form of a switch, which is operatively connected between each of the test systems 240A . . . 240K and the internal network 220 via a firewall 260C. The first communication unit or switch 260B may comprise the required resources with respect to network switching and the like and may additionally include any software or hardware resources so as to completely isolate a respective one of the test systems 240A . . . 240K from the internal network 220, as discussed above. Furthermore, the system 260 may comprise the first firewall 260C that is operatively connected between the internal network 220 and the switch 260B, wherein, as discussed above, the firewall 260C may be based on a set of static rules for regulating the data traffic between the switch 260B and the internal network 220, thereby avoiding a dynamic adaptation of the firewall 260C, which is usually associated with reduced security.

Moreover, a plurality of remote customer computer systems 280A . . . 280L may be connected to the network switch system 260 via one or more external networks 270. It should be appreciated that the network 270 is to represent an appropriate wide area network, which provides the required bandwidth for data transfer of the plurality of customers 280A . . . 280L with the environment 200, wherein, in some cases, at least some of the remote customers may have implemented a dedicated customer network connected to the system 260. As already discussed above, the system 260 is appropriately configured so as to provide controllable access to one or more of the test systems 240A . . . 240K while, in some embodiments, in dedicated critical situations, whereas, in other embodiments, the following feature is permanently active, a concurrent communication of the test systems 240A . . . 240K with the internal network 220 and the one or more external networks 270 may be prevented. For example, as illustrated in FIG. 2a, a second communication unit 260A of the system 260 in the form of a firewall may be connected between the one or more external networks 270 and the plurality of test systems 240A . . . 240K, that is, between the external network 270 and the switch 260B operatively connected to the plurality of test systems. As already discussed above, the communication unit or firewall 260A may include any hardware and software components as are typically required for implementing well-known firewall capabilities, while network switching and routing capabilities may be provided by the switch 260B. To this end, well-established components may be installed in combination with appropriately configured software components in the form of scripts and the like in order to impart the desired functionality to the communication unit or firewall 260A. Moreover, the allocation unit 290 may be connected to the system 260, directly or via the network 220, so as to at least control the switch 260B, for instance by activating physical switches configured to actually isolate the test systems 240A . . . 240K individually from the network 270, and/or by allowing or disallowing access to one or more of the test systems 240A . . . 240K based on software implemented rules. Consequently, the network firewall and switching system 260 may be appropriately configured to actually isolate the network 220 from the test systems 240A . . . 240K and to isolate the test systems from the network 270, wherein, in some illustrative embodiments, a corresponding isolation activity is controlled, for instance, by the allocation unit 290, such that concurrent access to the test systems 240A . . . 240K by the networks 220, 270 is prevented.

FIG. 2b schematically illustrates a portion of the secure zone 265, wherein, for convenience, only one of the test systems is shown. As an example the test system 240A is shown and may generally have any appropriate configuration so as to perform dedicated test procedures on the products at an appropriate stage of the overall manufacturing process. For example, the test system 240A may have basically the same configuration as discussed above with respect to the test system 140A (FIG. 1b). That is, the test system 240A may comprise automated test equipment in combination with an appropriate product handling system and a test program, wherein these components may be controlled by a corresponding station controller that communicates with the remaining components by means of a corresponding bus system, as is already discussed above with reference to the system 140A. In addition to the respective customer access points 231A, . . . , 231K, in some illustrative embodiments, additional resources may be provided in combination with at least some of the test systems 240A, . . . , 240K, as indicated by 230A. It should be appreciated, however, that some or all of the additional resources 230A may also be implemented in the system 240A, if considered appropriate. For instance, the resources 230A may be accessed via the customer access point 231A, which may thus be used for accessing respective measurement data, such as measurement data for electrical tests performed on wafer basis, also referred to as wafer sort test, while in other cases final test data obtained on the basis of packaged semiconductor devices, and the like may be provided for being accessed by a customer. Furthermore, a data processing component 234A may be provided for performing a pre-processing and/or postprocessing of measurement data. Moreover, additional resources, such as a file server 239A, a web server 238A, a computation server 237A may be implemented so as to allow to be accessed via the access point 231A and network 270 and the switch system 260. Consequently, an external customer may have full access to the test system 240A and the corresponding additional resources 230A, thereby offering superior performance and data manipulation capabilities, while still ensuring a high degree of data integrity at the customer side and at the side of the production environment, i.e. at the side of the internal network 220. It should be appreciated that the additional resources 230A may be implemented in the form of hardware components, such as one or more dedicated computer systems in combination with respective software applications that perform the corresponding tasks. In other cases, a common hardware platform may be provided for two or more of the test systems 240A, . . . , 240K, while the various resources may be implemented by separate software applications so as to enable unique association of software resources to a specific one of the test systems, thereby also preventing unwanted data transfer between respective test system specific resources.

FIG. 2b schematically illustrates a portion of the secure zone 265, wherein, for convenience, only one of the test systems is shown. As an example, the test system 240A is shown and may generally have any appropriate configuration so as to perform dedicated test procedures on the products at an appropriate stage of the overall manufacturing process. For example, the test system 240A may have basically the same configuration as discussed above with respect to the test system 140A (FIG. 1b). That is, the test system 240A may comprise automated test equipment in combination with an appropriate product handling system and a test program, wherein these components may be controlled by a corresponding station controller that communicates with the remaining components by means of a corresponding bus system, as is already discussed above with reference to the system 140A. In addition to the respective customer access points 231A . . . 231K (FIG. 2a), in some illustrative embodiments, additional resources may be provided in combination with at least some of the test systems 240A . . . 240K, as indicated by 230A. It should be appreciated, however, that some or all of the additional resources 230A may also be implemented in the system 240A, if considered appropriate. For instance, the resources 230A may be accessed via the customer access point 231A, which may thus be used for accessing respective measurement data, such as measurement data for electrical tests performed on wafer basis, also referred to as wafer sort test, while in other cases final test data obtained on the basis of packaged semiconductor devices and the like may be provided for being accessed by a customer. Furthermore, a data processing component 234A may be provided for performing a pre-processing and/or postprocessing of measurement data. Moreover, additional resources, such as a file server 239A, a web server 238A, a computation server 237A may be implemented so as to allow to be accessed via the access point 231A and network 270 and the switch system 260. Consequently, an external customer may have full access to the test system 240A and the corresponding additional resources 230A, thereby offering superior performance and data manipulation capabilities, while still ensuring a high degree of data integrity at the customer side and at the side of the production environment, i.e., at the side of the internal network 220. It should be appreciated that the additional resources 230A may be implemented in the form of hardware components, such as one or more dedicated computer systems, in combination with respective software applications that perform the corresponding tasks. In other cases, a common hardware platform may be provided for two or more of the test systems 240A . . . 240K, while the various resources may be implemented by separate software applications so as to enable unique association of software resources to a specific one of the test systems, thereby also preventing unwanted data transfer between respective test system specific resources.

The production environment 200 in combination with the one or more remote customer systems 280A . . . 280L, as shown in FIGS. 2a and 2b, may be operated so as to temporarily allow full external access to the test systems 240A . . . 240K, after a respective one of the test systems is assigned to a respective one of the remote customer computer systems. In some illustrative embodiments, the process of allocating test systems to specific customer systems and/or for specific tasks to be performed on one or more of the test systems may be controlled by the allocation unit 290, for instance based on user request entered via the user interface 291 or based on a request forwarded by any supervising control mechanism (not shown) via the internal network 220. Moreover, the current status of each of the test systems may be monitored by the allocation unit 290, wherein corresponding information may be presented to a user by means of the interface 291 and/or any such information may be forwarded to any other entity within the production environment 200 by means of the internal network 220. That is, performing a respective task in association with a dedicated one of the test systems, for instance re-allocation of a specific test system to a different customer, may result in a certain change of the status of a test system, and/or changes in the controlled network switch system 260 and/or in the respective applications running on the network firewall and switch system and/or the test systems and/or any associated additional resources, and these changes may be monitored and recorded by the allocation unit 290.

The allocation unit 290 may be implemented in the form of a software application in any appropriate hardware platform, such as any appropriate computer system, which provides the required computational resources for executing instructions, which, when executed by the hardware platform, result in the corresponding control functionality required for individually controlling access to the test systems 240A . . . 240K in the secure zone 265, while preventing direct external and internal access via the networks 220, 270. The corresponding set of instructions executed in the allocation unit 290 may be stored in a corresponding memory (not shown) internal or external to the unit 290. If externally stored, the instruction set may be transferred to the unit 290 by any appropriate data transfer channel, such as the internal network 220, possibly including wired and wireless communication channels, by using appropriate storage media and the like.

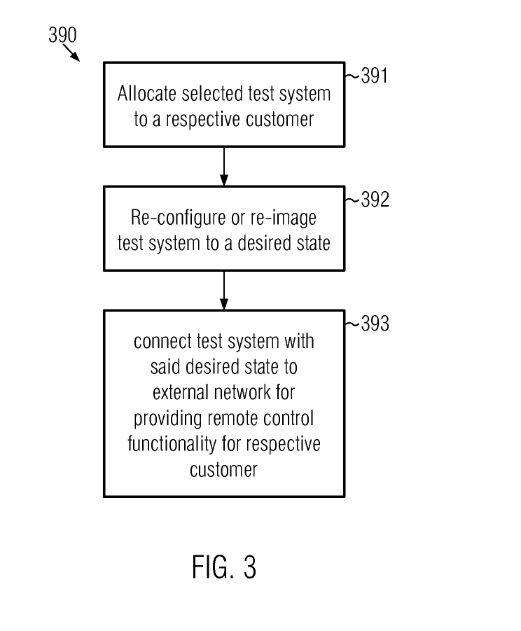

In the following, various tasks performed by the allocation unit 290 may be described with continued reference to FIGS. 2a and 2b and with reference to FIGS. 3-5.

FIG. 3 schematically illustrates a method 390 which may be implemented in the allocation unit 290 so as to enable allocation of one or more dedicated test systems to a respective external customer, while at the same time preserving data integrity with respect to other customers.

The implemented method 390 may be selected, for instance, by an operator or a supervising control mechanism in the production environment, wherein, in a first step 391, a test system is allocated to a respective customer. To this end, the operator within the production environment or an internal supervising control mechanism may select a test system that is appropriately equipped in order to perform the test programs required for a specific type of product of a specific customer. It should be appreciated that the selected test system may have been used in other test procedures and may thus be in a specific operational state, while also any associated additional resources, such as respective data base units and the like, may reflect the operational state and the previous use of the selected test system. For example, as previously discussed, a plurality of test procedures may be required at the various stages of forming complex semiconductor devices, thereby producing an immense body of measurement data, which in turn have to be processed and manipulated in order to obtain valuable information used for superior process control, verification of circuit designs and the like. Consequently, upon allocating the selected test system to a specific customer, the test system and any additional resources may contain information or may be in an operational state that could possibly reveal company internal information to an external customer.

For this reason, in step 392, the selected and allocated test system is re-configured or re-imaged in order to establish a desired operational state, which, on the one hand, ensures well-defined start conditions for a subsequent test procedure under external control by the specific customer and, on the other hand, does not reveal any critical information to the external customer upon accessing the allocated test system. It should be appreciated that the process in step 392 also encloses any associated resources, such as the various resources as described with reference to FIG. 2b. Hence, it is ensured that also any additional resources, such as data base units, data manipulation units and the like, will have a well-defined initial state that is appropriate for performing the required test operations without violating data integrity of the production environment.

In a step 393, the allocated test system is connected to the external network in order to provide remote control functionality for the corresponding external customer, wherein the connection may be made on the basis of the controllable network switch system 260 or by any other appropriate mechanism in order to physically connect the test system under consideration with the external network. It should be appreciated that providing the remote control functionality for the allocated test system, and any associated resources if provided, may additionally require an active control act from the allocation unit in order to actually allow or disallow external access to the allocated test system. A corresponding control act may be realized on the basis of a rule implemented in the controllable network switch system 260, which may be selected and thus activated by means of the allocation unit 290.

As a consequence, upon allocating a test system to an external customer computer system, an appropriate initial state is established in the test system and any associated resources, thereby “cleaning” the test system in order to avoid unwanted data transfer to the new customer.

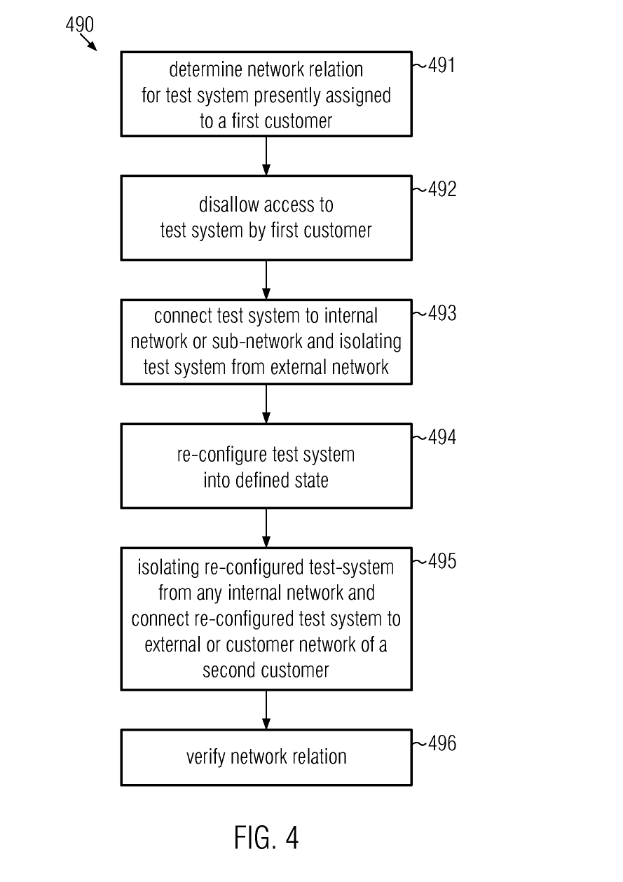

FIG. 4 schematically illustrates a process 490 that may also be implemented in the allocation unit 290 and which may have incorporated therein the process 390 previously described with reference to FIG. 3 in order to perform a change of customer for a dedicated test system. The process 490 begins at step 491, in which the network relation for a test system is determined that is presently assigned to a first customer and which is intended to be used by a second customer, for instance since a test phase of the first customer may be completed or the first customer may require a different type of test system, and the like. The determination of the network relation may be realized by means of the allocation unit 290 which may monitor and record the connection status of any of the test systems of the production environment. In other cases, any other component may be used to determine the network relation and the corresponding information may be forwarded to the allocation unit, for instance by means of the internal network 220, as previously described with reference to FIG. 2a.

In step 492, access to the test system by the first customer may be disallowed, which may be accomplished on the basis of selecting a corresponding rule implemented in the controllable network switch system, as already discussed above.

In step 493, the test system under consideration is connected to the internal network 220 or any sub-network and additionally the test system is isolated from the external network 270. As previously discussed, the connection and isolation may be established in some illustrative embodiments by using the controllable network switch system 260, wherein the allocation unit 290 may cause the network switch system to physically disconnect the test system under consideration from the external network, while, in other cases, the test system may be physically disconnected and moved within the production environment, depending on the overall factory internal requirements. Consequently, a concurrent direct communication of the test system under consideration with the internal network and the external network is efficiently prevented.

In step 494, the test system may be re-configured into a defined state, as is also described above with reference to the process 390. That is, after being connected to the factory internal resources, the test system under consideration may be manipulated in any desired manner without a connection to any external computer systems. For example, the re-configuration of the test system under consideration may include the saving of the test data gathered during a previous test phase under the control of the first customer. Consequently, the information obtained from customer assigned test systems, which may be considered as categorized information, since this information typically refers to specific products produced for a specific customer, remains available in the production environment and hence this information may be used for advanced process control strategies with respect to processes that may be specifically implemented in a process flow for producing the corresponding customer specific products. It should be appreciated, however, that the information obtained from customer specific test phases may be entered into the company internal database and may be categorized in any other appropriate manner.

In step 495, the isolation of the re-configured test system under consideration is initiated and subsequently the test system under consideration is connected to the external network or to a dedicated customer network of the second customer. Also in this case, the corresponding physical isolation and subsequent connection may be established on the basis of the controllable network switch system in combination with the allocation unit, as discussed above.

In step 496, the network relation of the re-configured test system may be verified, i.e., it may be ensured that the network relation determined in step 491 may be re-installed so as to ensure an appropriate connection status of the re-configured test system.

Consequently, communication of the test system under consideration with any internal resources of the production environment may be performed in a state in which the test system is isolated from any external networks, thereby ensuring data integrity of sensitive company internal data. At the same time, the re-allocation is accomplished by removing any critical information from the test system prior to providing remote control functionality to a new customer, while also remote access of the previous customer to the test system under consideration is disallowed, thereby accomplishing superior data integrity between different customers.

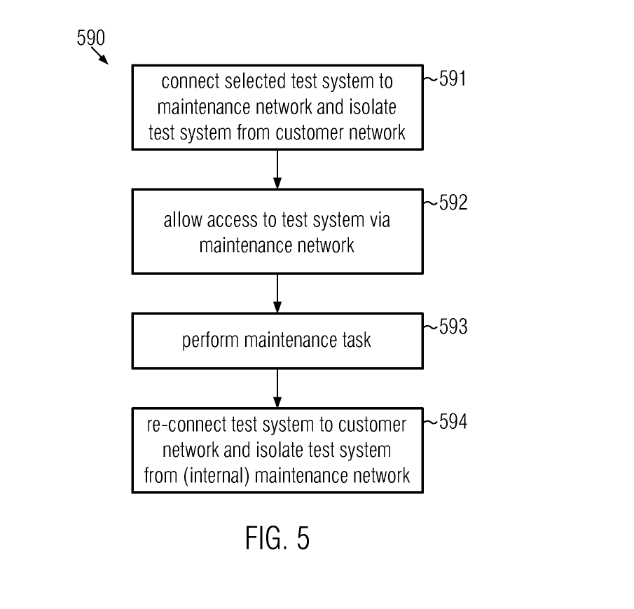

FIG. 5 illustrates a process 590, which may also be implemented in the allocation unit 290 and which may be activated when performing a maintenance task on a test system under consideration.

In step 591, the test system under consideration is connected to the internal network, such as a maintenance network, which may be understood as a sub-network or a substantially isolated network within the production environment and which may provide the required resources in order to initiate and perform required maintenance tasks. Additionally, the test system is isolated from the customer network or any external network, which may again be accomplished by means of the controllable network switch system, as already discussed above.

In step 592, the test system still assigned to a specific customer is manipulated so as to accept access via the maintenance network, which may be accomplished by changing the login procedure to the customer assigned login procedure.

In step 593, the maintenance task is performed, which may require access to the test system and corresponding activities by a technician, depending on the requirements with respect to the maintenance task under consideration.

In step 594, the test system is re-connected to the customer network or external network and also the system is isolated from the internal or maintenance network, thereby also preventing a concurrent direct access to the test system by any internal network and any external network. Also in this case, the controllable network switch system 260 may be used to establish a specific connection status, while, in other cases, the test system may physically be moved within the production environment, if required for performing the specific maintenance task.

It should be appreciated that the various process steps may be performed in a different order if compatible with the requirements of data integrity and the like. For instance, the connection of the test system under consideration to an internal or external network and the isolation of the corresponding test system may be performed such that data integrity is preserved, for instance, by first isolating the test system from one network and subsequently connecting the test system to another network. In other cases, as discussed above, the actual implementation of remote control functionality may additionally require an explicit act of allowing external access to the test system under consideration, so that the corresponding sequence of connecting and isolating the test system from respective networks may not be relevant.

As a result, the present disclosure provides a system and corresponding techniques for allocating one or more test systems to specific customers and/or for various tasks on the basis of an allocation unit, wherein direct access to company internal resources by an external customer is substantially prevented. In this manner, a very high level of security is achieved, for instance with respect to unwanted data and information transfer between different customers and also with respect to unwanted data and information transfer between the various customers and the production environment. Furthermore, customers may remain within their own network cloud without requiring a connection to other customer network clouds, if external access is accomplished for each of the customers on the basis of a dedicated customer network. In some illustrative embodiments, the re-allocation of a test system is accompanied by a “cleaning act,” that is, re-imaging or re-configuring of the test system prior to allowing access by a newly assigned customer. Hence, a dynamic assignment of test systems may be accomplished at a high level of security. Additionally, security may be enhanced by implementing static firewall rules, for instance in the controllable network switch system, since any real-time firewall changes are not required due to the above-explained secure procedure of changing customer assignments. Generally, any external access to a test system is handled by means of a secure zone, i.e., a DMZ, thereby avoiding direct access to the company internal network.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A production environment, comprising:
a test system configured to automatically obtain test data from products produced in said production environment;
a first communication network configured to enable communication of entities within said production environment;
a controllable network switch system operatively connected to said first communication network and said test system and connectable to a second communication network configured to enable communication of a remote customer computer system with said test system, said controllable network switch system configured to enable individual isolation of said first and second communication networks from said test system; and
an allocation unit operatively connected to said controllable network switch system and configured to cause said controllable network switch system to prevent concurrent communication of said first and second networks with said test system.

2. The production environment of claim 1, further comprising a second test system operatively connected to said first and second communication networks via said controllable network switch system.

3. The production environment of claim 2, wherein said allocation unit is further configured to control said controllable network switch system so as to individually enable communication of each of said test system and said second test system with said first and second networks.

4. The production environment of claim 2, wherein said allocation unit is further configured to allocate one of said test system and said second test system for communication with said customer computer system by controlling said controllable network switch system to disallow communication of said customer computer system with the other one of said test system and said second test system.

5. The production environment of claim 1, wherein said second communication network and said controllable network switch system are configured to enable communication of said test system with a plurality of customer computer systems including said customer computer system and wherein said allocation unit is configured to control said controllable network switch system so as to prevent concurrent communication of more than one of said plurality of customer computer systems with said test system.

6. The production environment of claim 5, wherein said allocation unit is further configured to allocate said test system for one of said plurality of customer computer systems upon receiving a request via said first communication network.

7. The production environment of claim 6, wherein said allocation unit is further configured to re-configure said test system prior to allocating said test system for said one customer computer system.

8. The production environment of claim 1, wherein said allocation unit is further configured to control said controllable network switch system to disallow communication of any of the remaining customer computer systems with said allocated test system.

9. The production environment of claim 2, wherein said first communication network comprises at least one first sub-network for connecting at least one of said test system and said second test system to a maintenance environment.

10. The production environment of claim 1, configured to at least test semiconductor products.

11. A method of operating a production environment, the method comprising:
allocating a test system of said production environment to a remote customer;
re-configuring said test system into a desired state by using an internal communication network of said production environment; and
connecting said test system to an external communication network so as to provide remote control functionality with respect to said test system for said remote customer.

12. The method of claim 11, further comprising disconnecting said test system from said internal communication network prior to providing said remote control functionality.

13. The method of claim 11, further comprising determining a relation of said test system to said external communication network and disconnecting said test system from said external communication network prior to re-configuring said test system.

14. The method of claim 13, further comprising verifying said relation of said test system to said external communication network upon connecting said allocated test system to said external communication network.

15. The method of claim 13, further comprising disallowing access to said allocated test system by any other remote customer via said external communication network.

16. The method of claim 11, further comprising controlling said remote control functionality over said allocated test system for said remote customer by allowing or disallowing access of said customer to said allocated test system by using a rule implemented in a network switch system connected between said test system and said external communication network.

17. The method of claim 11, further comprising performing a maintenance task by disconnecting said allocated test system from said external communication network and connecting said allocated test system to said internal communication network.

18. The method of claim 11, wherein said production environment is used to at least test semiconductor products.

19. A method, comprising:
providing a plurality of test systems implemented in a production environment, each of said plurality of test systems being connectable to an internal communication network and an external communication network, said external communication network providing remote control functionality with respect to said plurality of test systems for a plurality of remote customers, said internal communication network providing in situ control functionality with respect to said plurality of test systems;
allocating a respective one of said plurality of test systems to a respective one of said plurality of remote customers; and
controlling said remote control functionality and said in situ control functionality by preventing concurrent connection of said allocated test system to said internal and external communication networks.

20. The method of claim 19, further comprising tracking a status of at least said plurality of test systems and said internal and external communication networks so as to determine an allocation status of said plurality of test systems.
